(19) United States
(12) Patent Application Publication
(10) Pub. No.: US 2007/0297361 A1
(43) Pub. Date: Dec. 27, 2007

(54) Apparatus, method and software product for utilizing user equipment identification to add signaling information on a shared control channel

(76) Inventors: Karri Ranta-Aho, Espoo (FI); Antti Toskala, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/454,187

(22) Filed: Jun. 15, 2006

(51) Int. Cl. H04Q 7/00

(52) U.S. Cl. 370/329

(57) ABSTRACT

An apparatus, method, and software product are for masking a subframe of a shared control channel. A first part of the subframe is masked in a way specific to a user equipment, while using an identification of the user equipment. A remaining part of the subframe is masked using a second level masking operation, or at least using one other identification of the user equipment. This allows addition of more signaling information on an existing shared control channel, for example in the context of high speed downlink packet access.

### BACKGROUND OF THE INVENTION

1. Technical Field

The present invention pertains to the field of telecommunications. More particularly, the present invention pertains to transmission of packet data.

2. Discussion of Related Art

It is well known in the art that the Universal Mobile Telephony System (UMTS) Terrestrial Radio Access (UTRA) can accommodate Frequency Division Duplex (FDD), for example using Wideband Code Division Multiple Access (WCDMA). Downlink packet data transmission in UTRA FDD (WCDMA) is a feature that is included in Release 5 specifications of the Third Generation Partnership Project (3GPP), including the specifications for High Speed Downlink Packet Access (HSDPA). For general background about HSDPA, a good resource is the book WCDMA, Requirements and Practical Design by Rudolf Tanner and Jason Woodard (c. 2004). Sections 12.1 and 12.2 are especially useful (i.e. pages 335-358), and those two sections are incorporated herein by reference.

Downlink packet data transmission in UTRA FDD (WCDMA) is further enhanced in Release 6 of 3GPP, with the support of a Fractional Dedicated Physical Channel (F-DPCH) and the support of signaling radio bearer (SRB) mapping on the High Speed Downlink Shared Channel (HS-DSCH).

A terminal faces a problem dealing with modified signaling. If the signaling on the High Speed Shared Control Channel (HS-SCCH) is totally rewritten and new bits added, then the overhead increases. Due to the fact that the signaling on the HS-SSCH is based on the user identification, the quick solutions mentioned in some papers—or used with High Speed Uplink Packet Access (HSUPA) Enhanced Dedicated Absolute Grant Channel (E-AGCH)—would be to simply allocate multiple identifiers for one terminal. Such quick solutions, however, cause the problem of the terminal having to run several parallel decodings, because one must listen to four different HS-SCCHs in Release 6, and decide based on the decoder matrix for the first part which HS-SCCH to completely decode. This is because there is no Cyclic Redundancy Check (CRC) in the first part of HS-SCCH, and instead identification needs to be done by comparing the Viterbi matrix of all 4 HS-SCCHs.

One prior art solution is to use an additional identification (ID) for masking the new information. This, however, can result in doubling the number of decoder matrix comparisons from four to eight, with potential impact upon reliability as well. If more than just one additional bit is desired—for example, for the purpose of Multiple Input Multiple Output (MIMO) antenna phase information—then the complexity difference would only increase.

HS-SCCH structure and UE-ID usage are described in prior art standards. See, for example, 3GPP TS25.211 V.7.0.0 (2006-03), Physical channels and mapping of transport channels onto physical channels (FDD) (Release 7) which is incorporated by reference herein. TS25.211 discloses that the HS-SCCH has a fixed rate (60 kbps, SF=128) downlink physical channel which is used to carry downlink signaling related to HS-DSCH transmission. The sub-frame structure of the HS-SCCH is detailed in TS25.211.

Also incorporated by reference herein is 3GPP TS25.212 V.7.0.0 (2006-03), Multiplexing and channel coding (FDD) (Release 7), which discloses that physical channel mapping maps bits S1 to a first slot of the HS-SCCH sub-frame, after user equipment (UE) specific masking. This UE-specific masking is done using the UE-ID as described in chapter 4.6.7 of TS25.212. The physical channel mapping maps bits R2 to the second and third slots of the HS-SCCH sub-frame. These bits consist of a CRC (which is a kind of a check-sum) that is masked with the same UE-id, using the same method. Thus the first part (i.e. first slot) carries the UE-ID masked on it, and the second part (i.e. the remaining part consisting of the second and third slots) carry the UE-ID masked on the 16-bit CRC.

Unfortunately, these prior art technical specifications do not suggest any way to solve the problems that a UE faces when dealing with modified signaling. They do not solve the problem of the terminal having to run several parallel decodings. Various proposed Release 7 HSDPA improvements aim to use a modified version of the existing HSDPA signaling, but there remains the problem of the terminal having to run several parallel decodings.

### DISCLOSURE OF THE INVENTION

The present invention addresses signaling related to various proposed Release 7 HSDPA improvements which aim to use a modified version of the existing HSDPA signaling. Such proposals are related to either HSDPA cell change, uplink gating, downlink discontinuous reception (DRX) and HSDPA multiple input multiple output (MIMO).

The present invention includes a method for adding more signaling information on the existing HS-SCCH channel of the HSDPA. A second level masking operation and/or secondary UE IDs can be used for the second part of the HS-SCCH only. Alternatively, independent masking operations and/or UE IDs can be used for the first part and the second part of the HS-SCCH.

According to an embodiment of the invention, a first part of the subframe is masked in a manner specific to the UE, while using an identification of the UE. A remaining part of the subframe is masked using a second level masking operation, or at least using one other identification of the user equipment. This allows addition of more signaling information on the existing HS-SCCH.

### BRIEF DESCRIPTION OF THE DRAWINGS

FIG. 1 is a flow chart illustrating a method according to an embodiment of the present invention.

FIG. 2 is a block diagram illustrating and apparatus according to an embodiment of the present invention.

FIG. 3 is a flow chart illustrating various aspects of a coding chain according to an embodiment of the present invention.

### BEST MODE FOR CARRYING OUT THE INVENTION

An embodiment of the present invention will now be detailed with the aid of the accompanying figures. It is to be understood that this embodiment is merely an illustration of one particular implementation of the invention, without in any way foreclosing other embodiments and implementations.

A first embodiment of the invention is to use an additional second level masking operation (or alternative new terminal specific UE ID) for the second part of the HS-SCCH only, thus allowing the terminal initially to narrow down to the single HS-SCCH and then to check whether the CRC would go correctly with an additional masking sequence instead. This makes it possible to either only carry a new bit of information in the existence of a new masking sequence (such as an indication of the last packet for the terminal) or to have even more alternative masking sequences available to convey other issues, e.g. MIMO antenna weights as part of the signaling space.

Instead of the second level masking operation a modulo sum operation (i.e. a summation that if exceeding the maximum value results with the sum minus the maximum value) could be used as well.

In another embodiment of the invention, if the added complexity of introducing multiple UE-IDs to the first part is acceptable then the first part should be allowed to be masked with one UE-ID and the CRC of the second part should be allowed to be masked with another ID or with a second level masking operation. This way, simply by using different UE-ID combinations, N² different messages can be delivered to the UE. For example, if two UE-IDs would be used, then the UE could be given 2×2=4 different messages without interfering with the actual structure of the HS-SCCH. This method could be applied, for example, to signalling HSDPA MIMO antenna weights in the downlink.

The invention uses different UE-IDs for the UE-specific masking of the first part and the UE-specific masking of the CRC in the second part. A new ID for the second part could be replaced with the mentioned second level masking operation. Alternative embodiments can be described as follows:
1. The first part should always use a single specific UE-ID and the multiple UE-IDs (delivering additional information to the current HS-SCCH) are only used in the second part. This simplifies the receiver implementation.
2. The first and the second part use UE-IDs independently, to enable N² different combinations.

One useful way of implementing the invention is for the terminal to listen to the HS-SCCH pool indicated, and detect from the first part of the HS-SCCH that the data is intended for that device (the first part of the HS-SCCH has user identification plus codes to de-spread and modulate), whereupon the terminal proceeds to the second part and calculates the CRC results based on the two terminal IDs, and if the new ID (or the second level masking pattern) was used then that indicates, for example, the end of the packet sequence. A significant benefit of this being used as part of the packet reception is the fact that now a base transceiver station (BTS) gets feedback as to whether the message was actually received (in the form of ACK/NACK information).

Another useful way of implementing the invention is as just described, but allowing the alternative UE-IDs to be used independently in the two parts. A major benefit of doing so is a larger signaling space, since, for example, three UE-IDs would provide nine different messages instead of the three messages possible with the current structure. Alternatively, with the MIMO case, two HS-SCCHs can be used, and then the second level masking can be applied on both HS-SCCHs which the terminal has to receive.

A further advantage of the invention is that there is no need to have double HS-SCCH decoding resources, because the simple exclusive “or” operation (i.e. XOR operation) is used to test whether an alternative signature was used. The user identification is part of the CRC attachment process, so basically the use of N additional signatures can be covered by a CRC calculation that is N times parallel.

Because the CRC length is 16 bits, the impact to the signaling reliability is marginal, given that there exists now N correct outcomes for the CRC check instead of one as was the case earlier. The only added extra complexity is to run two or more CRC check operations, which are rather trivial for practical implementations. If the simplification is not taken in, then the usage of independent UE-IDs in the two parts enables an N² larger signaling space with the UE-ID usage than in current approaches.

Chapter 4.6.4 of TS25.212 describes CRC attachment for HS-SCCH. From the sequence of bits X_{1,1}, X_{1,2}, . . . , X_{1,8}, X_{2,1}, X_{2,3}, . . . , X_{2,13} a 16-bit CRC is calculated. This gives a sequence of bits C₁, C₂, . . . , C₁₆ where:

Cₖ=pᵢₘ₍₁₇₋ₖ₎ k=1,2, . . . ,16

### This sequence of bits is then masked with the UE Identity X_{ue,1}, X_{ue,2}, . . . , X_{ue,16} and then appended to the sequence of bits X_{2,1}, X_{2,2}, . . . , X_{2,13} to form the sequence of bits

Y₁, Y₂, . . . , Y₂₉, where

Yᵢ=X_{2,i} i=1,2, . . . ,13

Yᵢ=(Cᵢ₋₁₃+X_{ue,i-13}) mod 2i=14,15, . . . ,29

### The present invention provides for alternative UE IDs in the UE Identity Xᵤₑ.

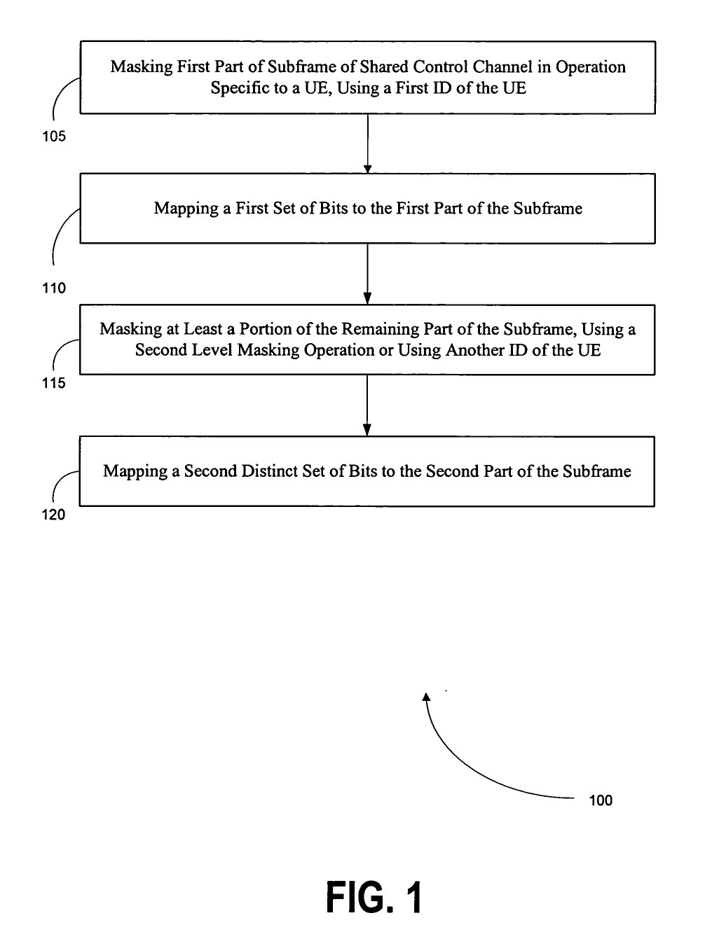

Turning now to the figures, FIG. 1 illustrate a method 100 according to the present invention. A first part of a subframe (of a shared control channel) is masked 105, using a first identification of a user equipment. Then, a first set of bits is mapped 110 onto the first part of the subframe. The remaining part of the subframe (or at least a portion of it) is masked 115, using a second level masking operation, or using another identification of the user equipment. Then, a second distinct set of bits is mapped 120 onto the second part of the subframe.

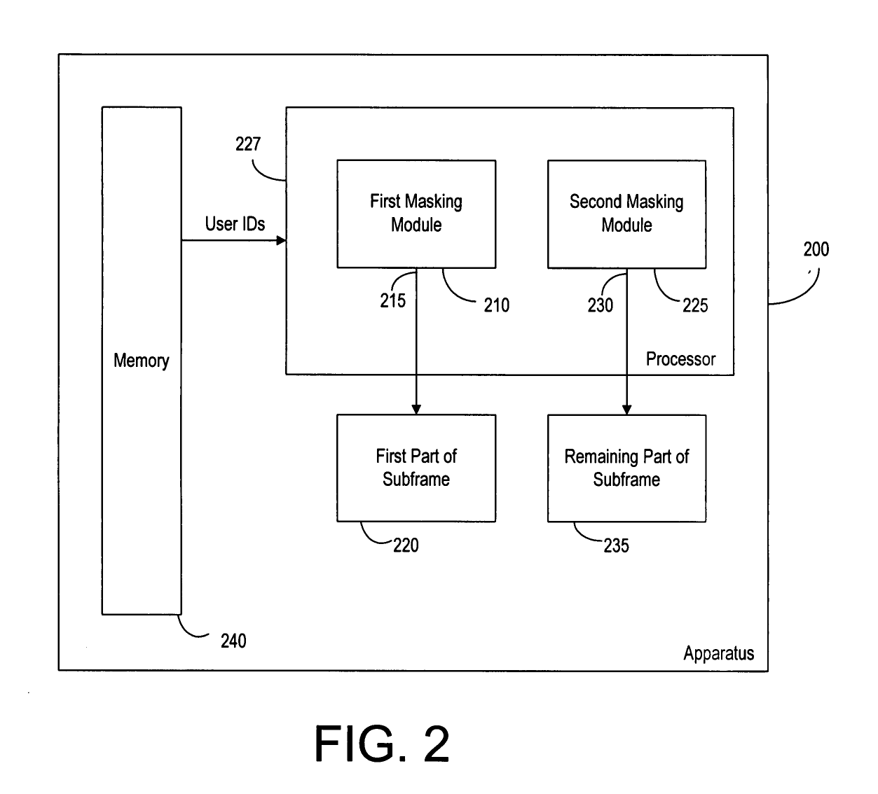

An apparatus 200 for performing the method of FIG. 1 is shown in FIG. 2. A processor 227 includes a first masking module 210 and a second masking module 225. The first masking module performs a masking procedure 215 on a first part of the subframe 220. The second masking module performs a masking procedure 230 on the remaining part of the subframe 235. The processor 227 is able to perform these masking operations by obtaining from the memory 240 a plurality of user Ids for the user equipment at issue.

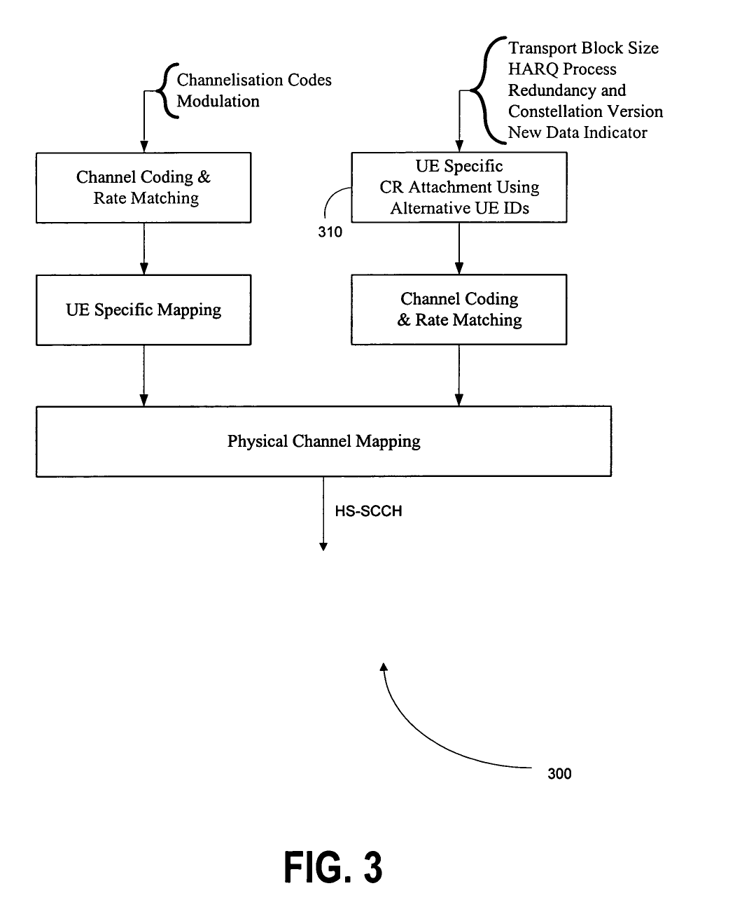

Turning now to FIG. 3, this shows a coding chain 300 for HS-SCCH. A person skilled in the art will understand that the procedure on the left-hand-side of FIG. 3 involves masking a first part of a subframe of the shared control channel HS-SCCH, and the procedure on the right-hand-side of FIG. 3 involves masking at least a portion of a remaining part of the subframe. The UE Specific CR Attachment 310 is analogous to the CRC attachment for HS-SCCH, as described at Chapter 4.6.4 of TS25.212. Unlike in the related art, the present embodiment of the invention utilizes alternative UE identifications during the UE-Specific Cyclic Redundancy Attachment 310.

Of course, the present invention also includes a software product for performing the embodiment of the method described above, and the software can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor such as the processor 227 shown in FIG. 2, comprising a single processing unit, multiple processing units capable of parallel operation, or the CPU can be distributed across one or more processing units in one or more locations, e.g., on a client and server, or within other components. The memory 240 shown in FIG. 2 may comprise any known type of data storage and/or transmission media, including magnetic media, optical media, random access memory (RAM), read-only memory (ROM), a data cache, a data object, or the like. Moreover, similarly to the CPU, the memory 240 may reside at a single physical location, comprising one or more types of data storage, or be distributed across a plurality of physical systems in various forms.

It is to be understood that all of the present figures, and the accompanying narrative discussions of corresponding embodiments, do not purport to be completely rigorous treatments of the method, apparatus, system, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method comprising:
masking a first part of a subframe of a shared control channel, in a first masking operation that is specific to a user equipment, using a first identification of the user equipment; and
using a second level masking operation, or at least one other identification of the user equipment, for masking at least a portion of a remaining part of the subframe.

2. The method of claim 1,
wherein the first identification is a predetermined identification of the user equipment, and
wherein the at least one other identification includes multiple identifications of the user equipment that are different from the first identification.

3. The method of claim 1,
wherein the at least one other identification of the user equipment consists of a single identification; and
wherein the first identification and the single identification are independently selectable from a plurality of possible identifications of the user equipment.

4. The method of claim 1, wherein the portion of the remaining part of the subframe includes a redundancy check.

5. The method of claim 1, wherein the subframe comprises three slots, the first part of the subframe comprises one of the three slots, and the remaining part of the subframe comprises another two of the three slots.

6. The method of claim 1, further comprising mapping a first set of bits to the first part of the subframe, and mapping a second distinct set of bits to the remaining part of the subframe.

7. The method of claim 3, wherein the number of possible identifications squared is how many combinations are possible of the first identification and the single identification.

8. An apparatus comprising:
means for masking a first part of a subframe of a shared control channel, in a first masking operation that is specific to a user equipment, using a first identification of the user equipment; and
means for using a second level masking operation, or at least one other identification of the user equipment, for masking at least a portion of a remaining part of the subframe.

9. The apparatus of claim 8,
wherein the first identification is a predetermined identification of the user equipment, and
wherein the at least one other identification includes multiple identifications of the user equipment that are different from the first identification.

10. The apparatus of claim 8,
wherein the at least one other identification of the user equipment consists of a single identification; and
wherein the first identification and the single identification are independently selectable from a plurality of possible identifications of the user equipment.

11. An apparatus comprising:
a first masking module configured to mask a first part of a subframe of a shared control channel, in a first masking operation that is specific to a user equipment, using a first identification of the user equipment; and
a second masking module, configured to use a second level masking operation, or at least one other identification of the user equipment, to mask at least a portion of a remaining part of the subframe.

12. The apparatus of claim 11,
wherein the first identification is a predetermined identification of the user equipment, and
wherein the at least one other identification includes multiple identifications of the user equipment that are different from the first identification.

13. The apparatus of claim 11,
wherein the at least one other identification of the user equipment consists of a single identification; and
wherein the first identification and the single identification are independently selectable from a plurality of possible identifications of the user equipment.

14. The apparatus of claim 11, wherein the portion of the remaining part of the subframe includes a redundancy check.

15. The apparatus of claim 11, wherein the subframe comprises three slots, the first part of the subframe comprises one of the three slots, and the remaining part of the subframe comprises another two of the three slots.

16. The apparatus of claim 11, further comprising mapping a first set of bits to the first part of the subframe, and mapping a second distinct set of bits to the remaining part of the subframe.

17. The apparatus of claim 13, wherein the number of possible identifications squared is how many combinations are possible of the first identification and the single identification.

18. A computer program product including a computer-readable medium having computer-executable components comprising:
a component for masking a first part of a subframe of a shared control channel, in a first masking operation that is specific to a user equipment, using a first identification of the user equipment; and
a component for using a second level masking operation, or at least one other identification of the user equipment, for masking at least a portion of a remaining part of the subframe.

19. The computer program product of claim 18,
wherein the first identification is a predetermined identification of the user equipment, and
wherein the at least one other identification includes multiple identifications of the user equipment that are different from the first identification.

20. The computer program product of claim 18,
wherein the at least one other identification of the user equipment consists of a single identification; and
wherein the first identification and the single identification are independently selectable from a plurality of possible identifications of the user equipment.
